(19) United States
(12) Patent Application Publication
(10) Pub. No.: US 2008/0195945 A1
(43) Pub. Date: Aug. 14, 2008

(54) Enterprise context

(75) Inventors: Misha Vaughan, Fremont, CA (US); Karl Mochel, San Francisco, CA (US); Patanjali Venkatacharya, Brisbane, CA (US); Phoebe Yang, Union City, CA (US); Beth Marx, San Francisco, CA (US)

Correspondence Address: Kraguljac & Kalnay, LLC, 4700 Rockside Road, Summit One, Suite 510, Independence, OH, 44131, US

(73) Assignee: ORACLE INTERNATIONAL CORPORATION, REDWOOD SHORES, CA (US)

(21) Appl. No.: 11/820,875

(22) Filed: Jun. 21, 2007

Related U.S. Application Data
(60) Provisional application No. 60/901,148, filed on Feb. 14, 2007.

(51) Int. Cl. G06F 3/00

(52) U.S. Cl. 715/708

(57) ABSTRACT

Systems, methods, media, and other embodiments associated with providing context relevant data and/or controls associated with an enterprise object processing application to a personal object processing application are described. One example system embodiment includes logic to receive an identifier of a selection associated with the personal object processing application, to receive a value associated with the selection, and to receive a metadata describing the selection, and/or the value. The example system embodiment also includes logic to provide a viewable region to display the context relevant data and/or controls for the personal object processing application. The context relevant action and the context relevant data are associated with an enterprise object processing application related to the selection.

### CROSS-REFERENCE TO RELATED APPLICATIONS

This application claims the benefit of U.S. Provisional Application 60/901,148, titled ENTERPRISE CONTEXT, filed Feb. 14, 2007. Additionally, this application is related to Provisional Application 60/901,149, titled ENTERPRISE CLIPBOARD, also filed on Feb. 14, 2007, which lists the same set of inventors and which has been assigned to the same assignee.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Conventionally it has been difficult, if possible at all, to fluidly transfer enterprise data between applications that operate on enterprise objects (e.g., enterprise applications) and applications that operate on personal objects (e.g., personal applications) while maintaining any context (e.g., user identity, user role, user business process, selection) associated with the data. “Selection” refers to an item that is the subject of a user identification action performed through the personal object processing application. For example, when a user clicks on a tab to select a spread sheet from a set of spread sheets, then the spread sheet would be the selection. When a user then clicks on a field in the spread sheet, the field would then become the selection.

Enterprise objects may be, for example, business objects (e.g., purchase orders, sales orders, recruiting requests), and other objects processed by, for example, enterprise applications. These objects tend to conform to pre-defined structures and to store pre-defined sets of information related in pre-defined ways. These objects also tend to belong to an organization (e.g., enterprise) rather than to any individual. Thus these objects tend to be processed by front office and/or back office applications that support a business process and that create and/or manipulate business objects.

A personal object may be, for example, a letter, a spread sheet, a contact, an email, and so on. These objects tend to be less structured and more user-defined than business objects. These objects may contain information acquired from a variety of places that may be inter-related in ad hoc user-defined ways. These objects tend to be processed by personal (e.g., productivity) applications (e.g., word processors, spread sheet applications, drawing applications), and so on. These personal applications generally have an interface that allows a selection to be made. The selection identifies a piece of data or information upon which the user of the personal application would like to work. Personal applications generally provide an editing environment where personal objects may be created and/or manipulated.

To summarize, enterprise applications tend to include business object processing logics while productivity applications tend to include personal object processing logics. Conventionally, context associated with business object processing and/or personal object processing has been lost when data has been moved from one type of application to the other. Considering how this data has conventionally been moved provides insight into why context may have been lost.

Consider preparing an email that reports on data found in different enterprise applications. For example, a manager may use a personal object processing application to prepare an email concerning monthly sales. The email may describe what has been sold, who sold it, to whom it has been sold, and how that will effect compensation. Thus, the manager may access different enterprise applications to gather the information. For example, the manager may access a purchasing application to retrieve purchase orders (PO) and then may access a personnel application to correlate PO information to salesman data and may access a client relationship application to correlate PO information to client data. Finally the manager may access an accounting application to determine the profitability of the sales and the resulting impact on compensation (e.g., bonus).

Conventionally, the manager may cut and paste data from one application into the email or, in some cases, may even have to write down some data using pen and paper before retyping it into the email. Clearly when pen and paper are used any context related to the data and/or its use is lost. This lost context may include information concerning who was accessing the data, in what role it was being accessed, from what type of equipment (e.g., desktop, laptop, Blackberry) it was being accessed, and so on. The context may similarly be lost during a cut and paste when, for example, a set of ASCII characters representing a string or number is copied from location A to location B. The copied characters may stand alone.

Enterprise integration applications deal with sharing data. But what they tend to do is to make inert data accessible throughout an enterprise. Other integration tools (e.g., data pipes) make shared data more live by periodically updating values fed through the pipes. While valuable, the up-to-date data remains simply an inert value, an out of context number or string whose essence (e.g., relationships, operations, views, metadata, context) remains with its creating and hosting application.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

Prior Art FIG. 1 illustrates clipboard-based data sharing.

Prior Art FIG. 2 illustrates pipe-based data sharing.

Prior Art FIG. 3 illustrates an enterprise integration server.

FIG. 4 illustrates an example system associated with creating, maintaining, and/or using enterprise context.

FIG. 5 illustrates an example system associated with creating, maintaining, and/or using enterprise context.

FIG. 6 illustrates an example method associated with creating, maintaining, and/or using enterprise context.

FIG. 7 illustrates an example computing environment in which example systems and methods illustrated herein can operate.

FIGS. 8-14 are simulated screen shots that may be produced by example systems and/or methods associated with creating, maintaining and/or using enterprise context.

### DETAILED DESCRIPTION

Establishing, maintaining, and/or using context may simplify and/or enhance tasks by making otherwise inert data come alive. For example, a field in an enterprise object processing application storing a dollar amount of a product sold may store more than just a number. The field may be associated with tools that facilitate examining and/or manipulating the number based on the context of the access. For example, an inside sales representative may be able to view the number in a currency that is related to a customer with whom they are interacting. The enterprise object processing application may be linked to a communication application that identifies the country of origin of a call received by the inside sales representative and may automatically present the number in both a local currency (e.g., U.S. dollars) and a currency relevant to the caller (e.g., Euros). Additionally, the field may be dynamically updated as additional sales occur. Thus, the field may include a “good through” identifier that indicates whether the number is up-to-date. When this number is cut and pasted from the enterprise object processing application into the manager email, it reverts to simply being an isolated piece of data, an inert number that can neither be dynamically updated nor dynamically displayed in relevant currency formats. Furthermore, the number loses its association to its “good through” identifier, leaving it as an undated snapshot.

Context may affect (e.g., filter) actions available to a field. For example, when the inside sales representative is accessing a field in an enterprise object processing application associated with fielding a customer inquiry, a first set of actions may be available (e.g., view value, view good-through data, convert currency). However, when the manager is accessing the field using an enterprise object processing application associated with determining a bonus, a second set of actions may be available (e.g., view value, view good-through date, view profit margin, view product sales history, view salesperson sales history). However, when a value from the field is copied into a personal object processing application, neither actions nor related data may be available to the personal object processing application because existing context is lost and no new context is created.

Example systems and methods concern creating, maintaining and/or using context associated with a selection. Example systems and methods also concern providing that context along with data associated with the selection when the data is moved between different types of applications (e.g., enterprise, personal) that process different types of objects (e.g., business, personal). The context may include, for example, user identity, user role, user task, business process, accessing application, related object, and so on. Creating and maintaining context may also include acquiring metadata associated with a selection.

Providing the data associated with a selection, related context, and related metadata facilitates providing enterprise-like processes, analytics, actions, and/or information to personal object processing applications. By way of illustration, if the manager copies the sales total field from an enterprise application to the email, the field may remain “live” and “in context” in the email. Thus, actions (e.g., view value, view good-through date, view profit margin) available to the manager when accessing the field in its parent/hosting application (e.g., enterprise object processing application) may still be available for the field in the email. Additionally, when the email is received, a subset of these actions and/or other actions may still be available to the recipient based on their context (e.g., identity, credentials, role, location).

Thus, context is detected, created, maintained, and/or brought along with data as it is moved from an application that processes one type of object (e.g., enterprise/business objects) to an application that processes a different type of object (e.g., personal objects). Detecting, creating, maintaining, and/or transporting context may facilitate providing both application specific actions (e.g., view value, view related values) and/or application independent actions (e.g., collaborative editing) that are available for enterprise data. The application independent actions may be provided by tools other than a specific enterprise application. These may understand enterprise objects and may have access to enterprise objects.

In one example, “capturing context” refers to acquiring information from a first situation that facilitates creating a context in a second situation. Data that may be captured may include a user name, a user identifier, a set of user credentials, data identifying a set of actions taken by a user, data identifying a role performed by a user, data identifying a business process in which the user is engaged, data identifying a set of open documents, data acquired from a user login screen, and so on.

“Capturing” data may include, for example, copying data values, establishing links to data, establishing pointers to data, establishing new data values, establishing new objects, and so on. This captured data may be stored on a machine-readable medium, in a memory, in an object(s), and so on. Example systems and methods may use the captured data to establish and/or maintain context for data in a receiving application (e.g., productivity application).

Example systems and methods establish a region (e.g., screen real estate) viewable for a personal object processing application. The region may contain a sub-region that contains information and actions related to the contents of an editing space in the personal object processing application. A sub-region may also contain data corresponding to context information generated via interactions in an application and/or received from interactions with other utilities and/or applications.

Example systems and methods give a personal object processing application user access to business processes, analytics, actions, and/or information that are relevant to their work as defined by the data retrieved from enterprise applications and the enterprise applications from which the data was retrieved. Additionally, example systems and methods give an application access to overarching tools (e.g., collaborative editing) typically available to enterprise applications but not productivity applications.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Machine-readable medium”, as used herein, refers to a medium that participates in directly or indirectly providing signals, instructions and/or data. A machine-readable medium may take forms, including, but not limited to, non-volatile media (e.g. ROM, disk) and volatile media (RAM). Common forms of a machine-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, executable software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing executable instructions, and so on. Logic may include one or more gates, combinations of gates, or other circuit components. Logic may also be fully embodied as executing instructions. Where multiple logical logics are described, it may be possible to incorporate the multiple logical logics into one physical logic. Similarly, where a single logical logic is described, it may be possible to distribute that single logical logic between multiple physical logics.

“Object” is used herein as its computer science term of art usage. Thus, “object”, refers to a single logical entity that includes a collection of data and methods for processing that data. Some data may be public while other data may be private. Similarly some methods may be public while other methods may be private. Example methods may include constructors, destructors, get/set methods, and so on.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more executable computer or processor instructions that can be read, interpreted, and/or executed and that cause a computer, processor, or other electronic device to perform functions, actions and/or behave in a desired manner. The instructions may be embodied in various forms including routines, algorithms, modules, methods, threads, and/or programs. Software may also be implemented in a variety of executable and/or loadable forms including, but not limited to, a stand-alone program, a function (local and/or remote), a servelet, an applet, instructions stored in a memory, part of an operating system or other types of executable instructions. It will also be appreciated that machine-readable and/or executable instructions can be located in one logic and/or distributed between two or more communicating, co-operating, and/or parallel processing logics and thus can be loaded and/or executed in serial, parallel, massively parallel and other manners.

Software, whether an entire system or a component of a system, may be embodied as an article of manufacture and maintained or provided as part of a machine-readable medium as defined previously. Another form of software may include signals that transmit executable instructions to a recipient over a network or other communication medium.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here and generally is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and so on.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, calculating, determining, displaying, and so on, refer to actions and processes of a computer system, logic, processor, or similar electronic device that manipulates and transforms data represented as physical (electronic) quantities.

Prior Art FIG. 1 illustrates clipboard-based data sharing. A first application 100 may process a value 110. Application 100 may be, for example, a business object processing application that processes business objects 180 (e.g., purchase order, sales order, recruiting request). Context relevant actions and data (e.g., 122 and 124 through 128) may be associated with value 110. Metadata 130 may describe value 110 and context 140 may describe the circumstances involved in processing value 110.

A second application 160 may also process a value 170. Application 160 may be, for example, a personal object processing application that processes personal objects 190 (e.g., word processor document, spread sheet, email). Application 160 may include a command space (area above line A-A) in which standard personal object processing commands (e.g., 180 and 182 through 188) associated with application 160 are available. A clipboard 150 may be used to provide application 160 with a value from application 100. The value 110 may be copied to clipboard 150 and then to value 170. This value would be a static (e.g., written once) value that may or may not retain any information associated with the value at all. For example, even the format of the value may be lost. In one example, some metadata 130 may be provided along with the value provided through clipboard 150. For example, in a clipboard-based DHTML (dynamic hypertext markup language) data transfer, the format of the value copied may be provided. Regardless of how the conventional clipboard transfer occurs, no context is created, maintained, and/or available at application 160. Thus, value 170 is “just data” to application 160. No additional data and/or actions can be provided to application 160 based on the arrival of value 170.

Prior Art FIG. 2 illustrates pipe-based data sharing. Prior Art FIG. 2 illustrates a first application 200 that may process a value 210. Application 200 may process business objects 280. Context relevant actions and data (e.g., 222 and 224 through 228) may be associated with value 210, as may metadata 230 and context 240. A second application 260 may also process a value 270. Application 260 may process personal objects 290. Application 260 may include a command space (area above line A-A) in which standard personal object processing commands (e.g., 280 and 282 through 288) associated with application 260 are available. A pipe 250 may be used to provide application 260 with a value from application 200. Unlike value 170 (Prior Art FIG. 1), value 270 may be kept up-to-date in application 260. However value 270 remains “just data” since no context was created, maintained, and/or used by either application 200 or 260 as a result of or in association with transferring the value across pipe 250.

Prior Art FIG. 3 illustrates an enterprise integration server 320 that attempts to integrate data from different business object processing applications (e.g., 300 . . . 310) to which server 320 is connected. Enterprise integration server 320 may store business data objects, enterprise objects, and/or data associated with these types of objects. Enterprise server 320 may also be connected to a personal object processing application 330. Application 330 operates on personal objects, and may even receive some data from enterprise server 320. However, this data will be “just data”, and will not carry or be related to context. Use of this data will therefore be limited to the actions available in the personal object processing application 330.

Server 320 may employ techniques including data consolidation, data federation, and/or data propagation to attempt to integrate data between applications 300 through 310. Regardless of technique, the data available to application 330 will remain “just data”. Data consolidation may be performed by a set of processes that capture, cleanse, integrate, transform, and/or load data into a target data store. Note that no context is created and/or maintained. Data may be consolidated from operational data sources and loaded into intelligence data stores including, for example, a data warehouse, an operational data store, a data mart, and so on. Data federation may be performed by a set of processes that provide real-time integrated views of different data types available in different data sources. The integrated view may be provided by a universal data access layer. While this makes more types of data available to more types of applications, the federated data remains “just data”. Data federation typically produces virtual data stores and virtual views of data. Data propagation may be performed by a set of processes that centralize and optimize application integration using, for example, bulk data transfers. Once again, propagated data remains just data.

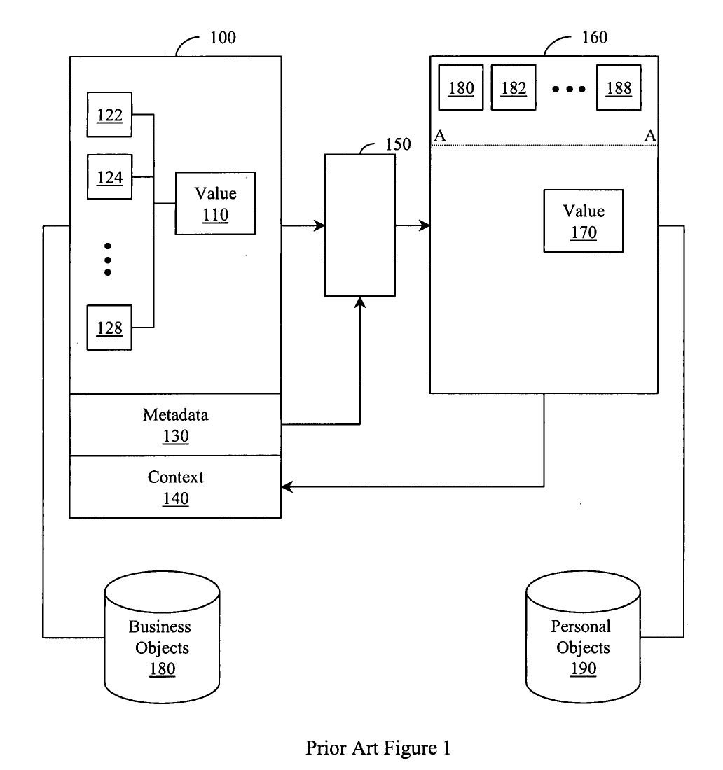

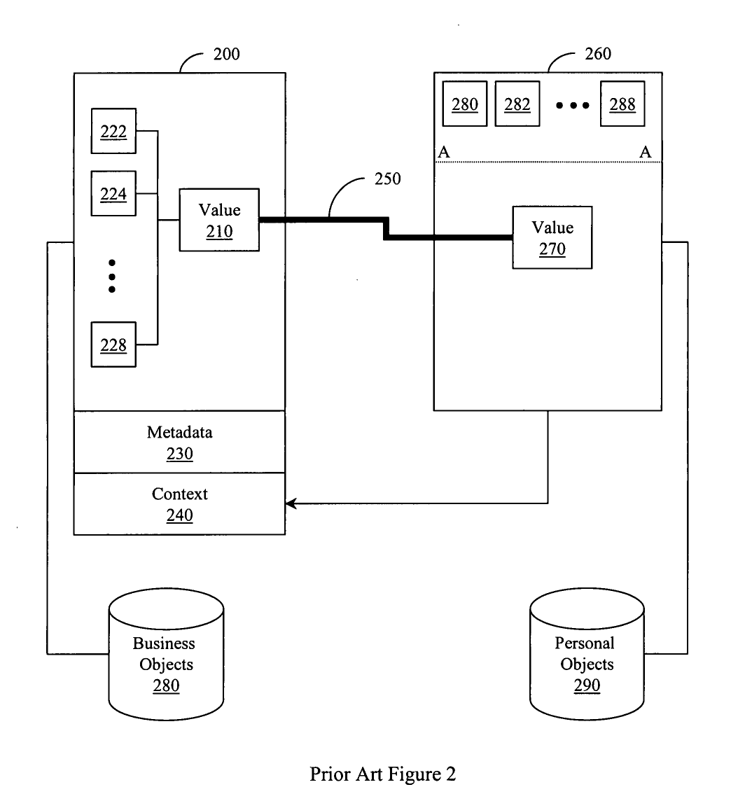

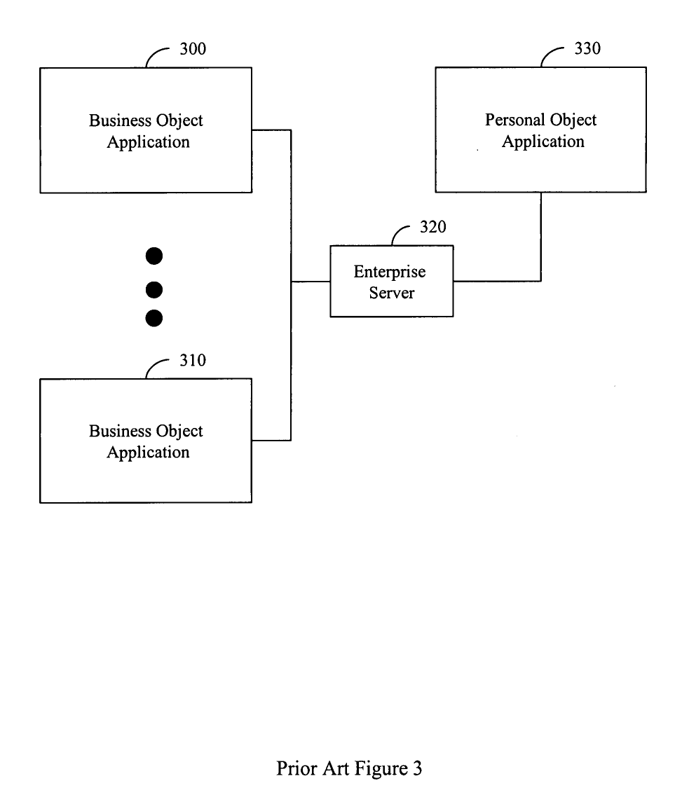

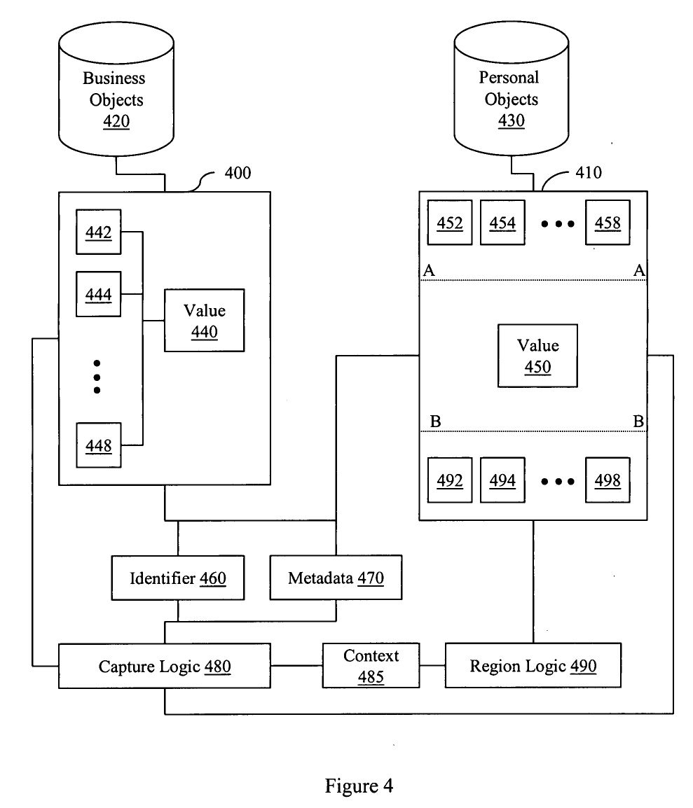

FIG. 4 illustrates an example system associated with creating, maintaining, and/or using enterprise context. A first application 400 may be, for example, a business object processing application that processes business objects 420. Application 400 may be, for example, a front office application (e.g., customer relationship), a back office application (e.g., accounting), and so on. Application 400 may process a value 440 for which a set of data and/or actions 442 and 444 through 448 are available. This set of data and/or actions 442 through 448 are data and/or actions typically associated with enterprise objects, business objects, and so on.

A second application 410 may be, for example, a personal object processing application (e.g., word processor, contact manager) that processes personal objects 430 (e.g., documents, contacts). Application 410 may process a value 450 for which a set of data and/or actions 452 and 454 through 458 are available. Typically the set of data and/or actions 442 through 448 would not be available to application 410, even if value 450 derived from or was related to value 440. In one example, either the first application 400 and/or the second application 410 may be Oracle® Fusion® applications.

In one example, the system may include a capture logic 480. Capture logic 480 may be tasked to receive an identifier 460 of a selection associated with application 410. The identifier may be, for example, a GUID (globally unique identifier), a URL (uniform resource locator), a pointer, and so on. The selection may identify, for example, an object, a field, a control, and so on. Capture logic 480 may also receive a value associated with the selection and a metadata 470. The metadata 470 may describe the selection, the value 450, the application 410, the application 400, the data and/or actions 442 through 448, and so on. In addition to describing items, the metadata may include links to other values, links to other documents, and so on.

Thus, the metadata 470 may include data describing a personal object associated with the selection and/or a personal object processing application associated with the selection. The metadata 470 may also include data describing an enterprise object associated with the selection and/or an enterprise object processing application associated with the selection. Metadata 470 may also include a format associated with the value, a freshness associated with the value, a source associated with the value, an access time associated with the value, a recipient of the value, a provider of the value, and a document associated with the value.

The capture logic 480 may create a context 485 from the identifier 460, the value, and/or the metadata 470. The context 485 facilitates identifying who was using application 410, upon what data application 410 was acting (e.g., value 450), how application 410 was processing that data, and so on. Thus, the context 485 may include data including an identifier of a selection user, a user name associated with the selection user, a security credential associated with the selection user, a task associated with the selection user, a role associated with the selection user, a location of the selection user, an object associated with the value, an object associated with the selection, and an object associated with the selection user. This context may facilitate identifying members of the data and/or actions 442 through 448 that are relevant to what is happening in application 410.

As described above, data and/or actions 442 through 448 would not typically be available to application 410. This example system facilitates providing a set of additional data items and/or actions 492 and 494 through 498 to application 410. These data items and/or actions 492 through 498 may be related to (e.g., derived from, linked to) data items and/or actions 442 through 448. Thus, logic is provided to select and create paths to additional data items and/or actions 492 through 498.

In one example, a region logic 490 is to provide a viewable region for the personal object processing application 410. In this example, the viewable region is represented as the area below line B-B. The viewable region may display a context relevant action associated with the selection, and/or a context relevant data associated with the selection. As described above, the context relevant action and the context relevant data are associated with an enterprise object processing application 400 related to the selection. The context relevant action may be, for example, a business analytic associated with the enterprise object, a business task associated with the enterprise object, and so on. The context relevant data may be, for example, data associated with the enterprise object. The region logic 490 may produce the context relevant action associated with the selection and the context relevant data associated with the selection based on the context 485.

While personal objects and enterprise objects are described above, the following example illustrates how a template may also be used to pass context. Consider, for example, a user of a first application who selects a template from a second application to download into the first application. The template may have been pre-configured to have dynamic data bindings to, for example, a database, a data feed, a real time data acquisition system, and so on. If the template is selected, example systems and methods facilitate passing enterprise context related to that template. Consider a “quote” template that already has a set of quote fields associated with it. Selecting the quote template may allow enterprise context (e.g., related actions, related business processes, related alerts, related notifications, key performance indicators, and so on) to be made available in the side pane area.

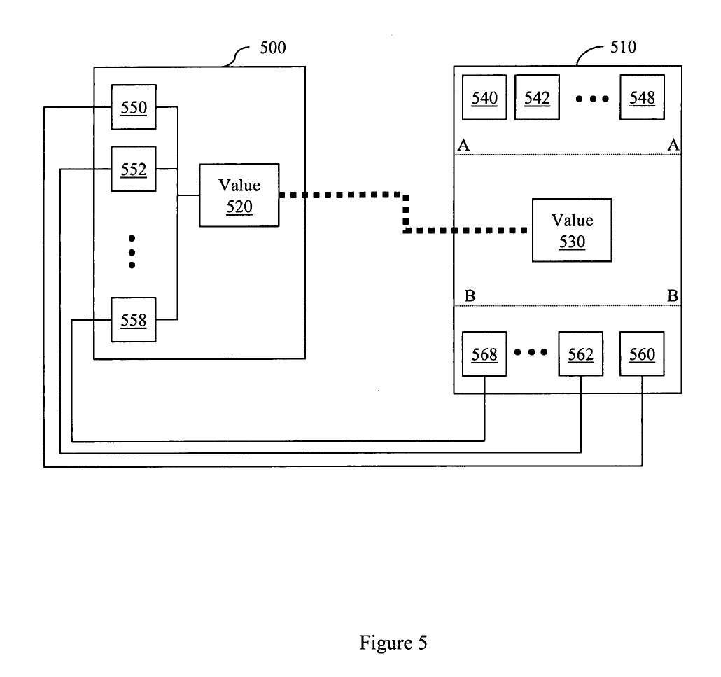

FIG. 5 illustrates a system where a value 530 associated with a first application 510 (e.g., personal object processing application) is kept current with a value 520 associated with a second application 500 (e.g., business object processing application). Application 510 may have a set of display elements 540 and 542 through 548 related to value 530. Similarly, application 500 may have a set of display elements 550 and 552 through 558 related to value 520. The display elements may be, for example, data displays (e.g., field, table, graph, ticker), control displays (e.g., button, slider, menu, checkbox), and so on. Capturing context associated with application 510 facilitates making members of 550 through 558 available as display elements 560 and 562 through 568 for processing value 530 in application 510.

Example methods may be better appreciated with reference to flow diagrams. While for purposes of simplicity of explanation, the illustrated methods are shown and described as a series of blocks, it is to be appreciated that the methods are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methods can employ additional, not illustrated blocks. While the figures illustrate various actions occurring in serial, it is to be appreciated that various actions could occur concurrently, substantially in parallel, and/or at substantially different points in time. In one example, blocks may represent executable instructions that cause a computer, processor, and/or logic device to respond, to perform an action(s), to change states, and/or to make decisions. Thus, the described methods can be implemented as processor executable instructions and/or operations provided by a machine-readable medium. In another example, blocks may represent functions and/or actions performed by functionally equivalent circuits such as an analog circuit, a digital signal processor circuit, an application specific integrated circuit (ASIC), or other logic device.

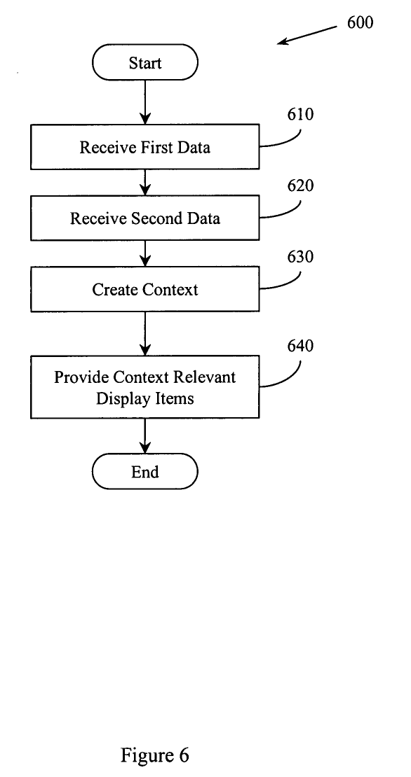

FIG. 6 illustrates a method 600 associated with creating, maintaining, and/or using enterprise context. Method 600 may include, at 610, receiving a first set of data from a personal object processing logic. The personal object processing logic may be, for example, a productivity application (e.g., word processor, contact manager, spread sheet). The first set of data may include a selection identifier associated with the personal object processing logic. The selection identifier may identify a data item or a set of data items being processed by the personal object processing logic. The selection identifier may be, for example, a globally unique identifier (GUID), a uniform resource locator (URL), an object identifier, a pointer value, and so on. In one example, the first set of data may include a personal object, a personal object identifier, a value available in the personal object, a personal metadata, a personal object processing logic identifier, and so on. Thus, the first set of data relates to the personal object processing application from which the selection identifier was received.

In one example, the personal metadata may include data that describes the value, the selection, an object associated with the value and/or selection, and so on. Metadata may also include, for example, links to other values, links to other documents, and so on. The personal metadata may include data describing a format of the value, a freshness associated with the value, a freshness associated with the personal object, a source associated with the value, a source associated with the personal object, an access time associated with the value, an access time associated with the personal object, a document associated with the value, and so on.

Method 600 may also include, at 620, receiving a second set of data from an enterprise object processing logic. The enterprise object processing logic may be, for example, an enterprise application (e.g., front office application, back office application). The second set of data that is received may be determined, at least in part, by the selection identifier. For example, data relevant to the selection may be identified and received. The data may be associated with an enterprise object processed by the enterprise object processing application. Thus the second set of data may include, for example, an enterprise object, an enterprise object identifier, an enterprise metadata, an enterprise object processing logic identifier, and so on.

In one example, the enterprise metadata may include data identifying a set of actions available to process the enterprise object. For example, business processes and analytics may be available for an enterprise object, thus the enterprise metadata may include data identifying these actions and/or providing paths (e.g., addresses, links, pointers) to machine executable instructions to perform the actions.

Method 600 may also include, at 630, creating a context associated with the personal object processing logic. This context may depend on data associated with a selection identified by the selection identifier. The context facilitates identifying, for example, who was processing a piece of data, what piece of data was being processed, from where it was being processed, when it was being processed, and/or how it was being processed. Thus, the context may include a selection user identifier, a selection user security metadata, a selection user task, a selection user role, and so on.

The context facilitates identifying what data and/or actions associated with an enterprise object may be made available to a user of a personal object through the set of context relevant display objects. In one example, the set of context relevant display objects may include a context relevant data item related to a data item associated with the enterprise object. This data item may be, for example, background data (e.g., creator, creation date, confidence), data upon which a value was computed, data that facilitates understanding the value, and so on. In one example, the set of context relevant display objects may include a context relevant control item related to an action associated with the enterprise object. The context relevant control item may be associated with, for example, a business process, a business analytic, and so on, associated with a business or enterprise object. These business processes and/or business analytics would not typically be available to a user of a personal object processing application.

Having created a context and having determined data and/or actions associated with a selection in a personal object processing application, method 600 may include, at 640, providing to the personal object processing logic the set of context relevant display elements. Which context relevant display elements are provided will depend on the context created at 630.

While FIG. 6 illustrates various actions occurring in serial, it is to be appreciated that various actions illustrated in FIG. 6 could occur substantially in parallel. By way of illustration, a first process could receive first and second data. Similarly, a second process could create context while a third process could provide the context. While three processes are described, it is to be appreciated that a greater and/or lesser number of processes could be employed and that lightweight processes, regular processes, threads, and other approaches could be employed.

In one example, methods are implemented as processor executable instructions and/or operations stored on a machine-readable medium. Thus, in one example, a machine-readable medium may store machine executable instructions operable to perform method 600. It is to be appreciated that other machine executable example methods described herein can also be stored on a machine-readable medium.

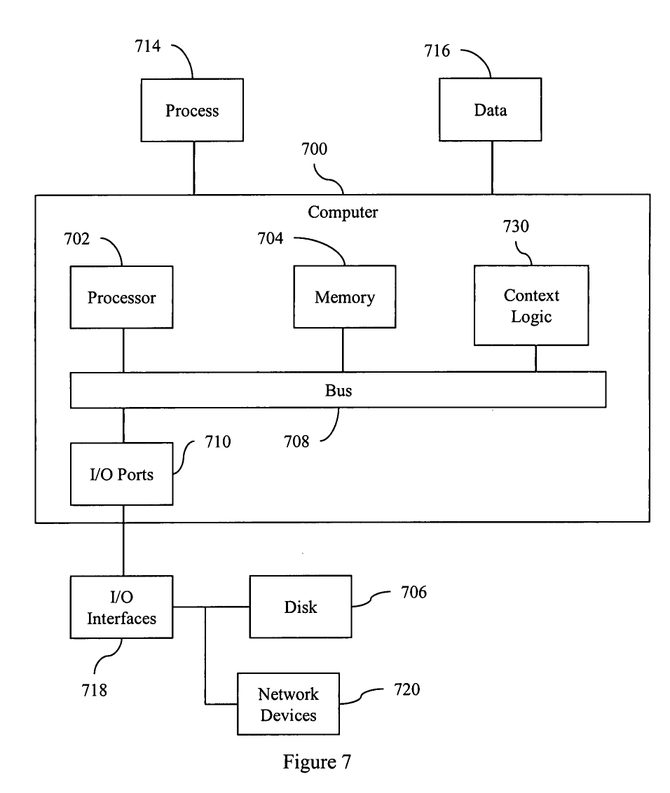

FIG. 7 illustrates an example computing device in which example systems and methods described herein, and equivalents, can operate. The example computing device may be a computer 700 that includes a processor 702, a memory 704, and input/output ports 710 operably connected by a bus 708. In one example, the computer 700 may include a context logic 730 configured to facilitate detecting, creating, maintaining, and/or using context. Context logic 730 may include means (e.g., hardware, executable instructions, firmware) for receiving a first data concerning a selection in a personal object processing application and means (e.g., hardware, executable instructions, firmware) for receiving from an enterprise object processing application a second data related to the selection. Context logic 730 may also include means (e.g., hardware, executable instructions, firmware) for creating a context for the selection based, at least in part, on the first data and the second data, and means (e.g., hardware, executable instructions, firmware) for providing to the personal object processing application data and functionality associated with the enterprise object processing application. Which data and functionality are provided are determined by the context.

Generally describing an example configuration of the computer 700, the processor 702 can be a variety of various processors including dual microprocessor and other multi-processor architectures. The memory 704 can include volatile memory and/or non-volatile memory. The non-volatile memory can include, but is not limited to, ROM, PROM, EPROM, EEPROM, and so on. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 706 may be operably connected to the computer 700 via, for example, an input/output interface (e.g., card, device) 718 and an input/output port 710. The disk 706 can include, but is not limited to, a magnetic disk drive, a solid state disk drive, a floppy disk drive, a tape drive, a Zip drive, a flash memory card, and/or a memory stick. Furthermore, the disk 706 can include optical drives including a CD-ROM, a CD recordable drive (CD-R drive), a CD rewriteable drive (CD-RW drive), and/or a digital video ROM drive (DVD ROM). The memory 704 can store processes 714 and/or data 716, for example. The disk 706 and/or memory 704 can store an operating system that controls and allocates resources of the computer 700.

The bus 708 can be a single internal bus interconnect architecture and/or other bus or mesh architectures. While a single bus is illustrated, it is to be appreciated that computer 700 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 700 may interact with input/output devices via i/o interfaces 718 and input/output ports 710. Input/output devices can include, but are not limited to, a keyboard, a microphone, a pointing and selection device, cameras, video cards, displays, disk 706, network devices 720, and so on. The input/output ports 710 can include but are not limited to, serial ports, parallel ports, and USB ports.

The computer 700 can operate in a network environment and thus may be connected to network devices 720 via the i/o interfaces 718, and/or the i/o ports 710. Through the network devices 720, the computer 700 may interact with a network. Through the network, the computer 700 may be logically connected to remote computers. The networks with which the computer 700 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and so on. Similarly, the network devices 720 can connect to WAN technologies including, but not limited to, point to point links, circuit switching networks (e.g., integrated services digital networks (ISDN)), packet switching networks, and digital subscriber lines (DSL).

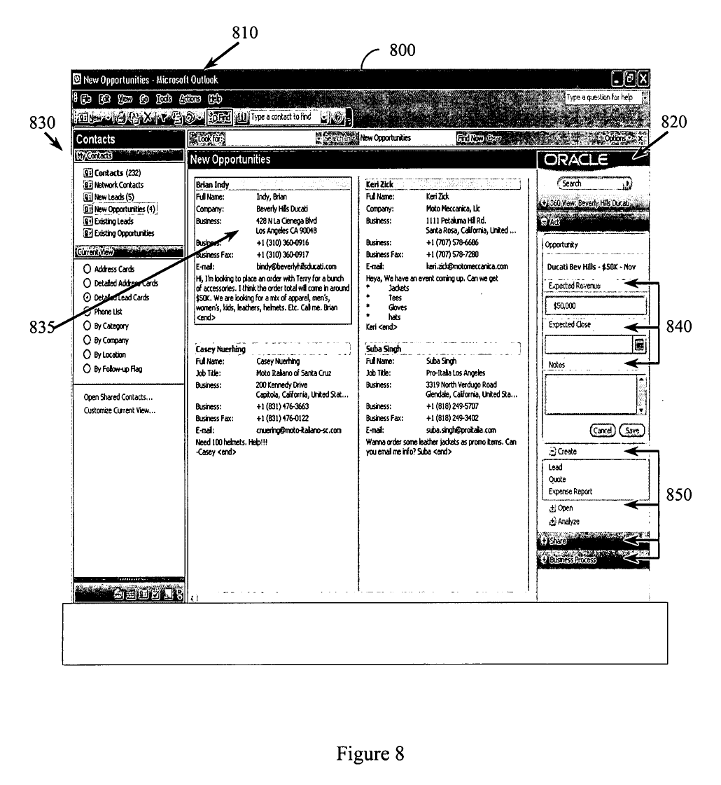

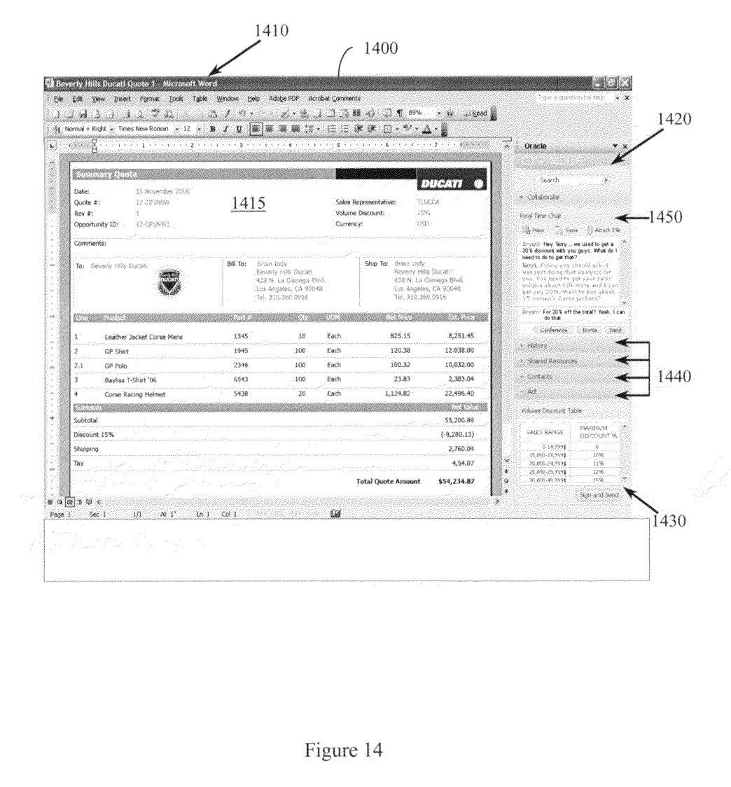

FIGS. 8-14 represent simulated screen shots produced by example systems and/or methods associated with creating, maintaining and/or using enterprise context.

FIG. 8 illustrates a simulated screen shot 800 showing a personal object processing application 810 (Outlook Contact Manager) and a region 820 produced by an example system and/or method. A personal object organization area 830 and data associated with a personal object 835 appear in application 810. Additional context relevant data 840 and controls associated with additional context relevant actions 850 appear in region 820. The additional data 840 and additional controls 850 are context relevant to a selection made in personal object processing application 810. In the screen shot 800, the Brian Indy contact related to Beverly Hills Ducati has been selected. The additional data 840 and/or additional controls 850 would not typically be available to personal object processing application 810. They are available since context associated with application 810 (e.g., user, role) has been detected and/or established to create and/or maintain context for region 820. Which data 840 can be displayed depends both on the selection and the context relevant to that selection. Similarly, which actions 850 can be displayed depends both on the selection and the context relevant to that selection. The data and actions may be associated with a business object(s) to which a relationship can be established and/or maintained based on the created/maintained context. It is to be appreciated that in some examples area 830 could combine personal object data and application object data.

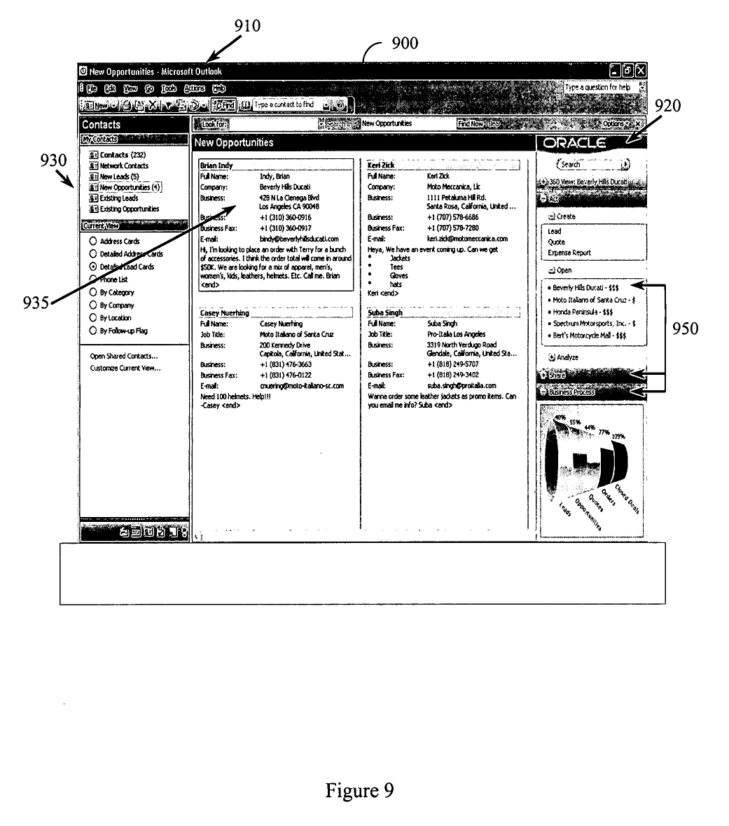

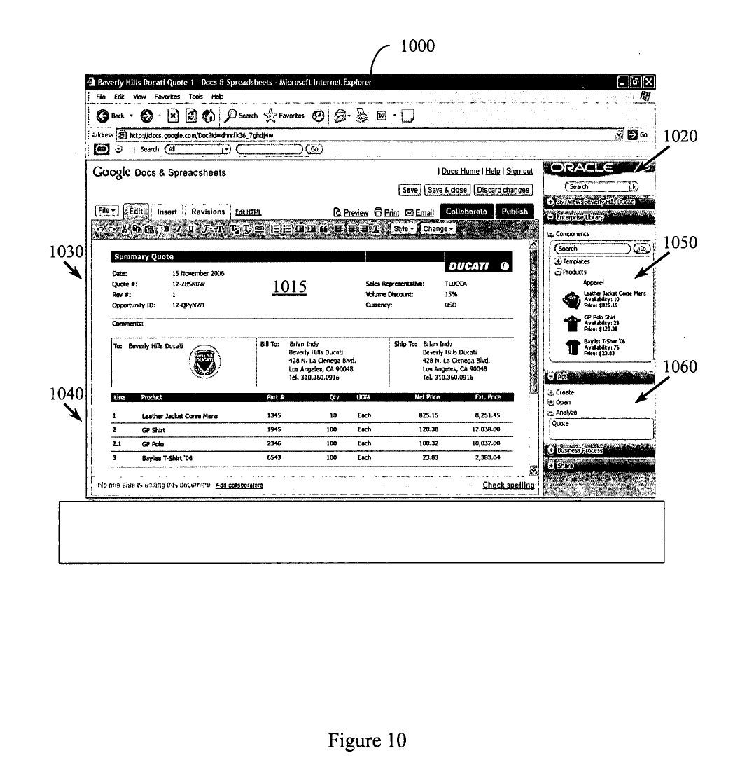

FIG. 9 illustrates a simulated screen shot 900 showing a personal object processing application 910 and a region 920 produced by an example system and/or method. A personal object organization area 930 and data associated with a personal object 935 appear in application 910. Additional context relevant data and controls associated with additional context relevant actions 950 appear in region 920. The additional data and actions 950 are context relevant to a selection made in personal object processing application 910. In the screen shot 900, a user has the option to open a quote associated with the contact selected (e.g., personal object 935). FIG. 10 illustrates the effect of opening the quote. Once again it is to be appreciated that in some examples area 930 could combine both personal object data and application object data.

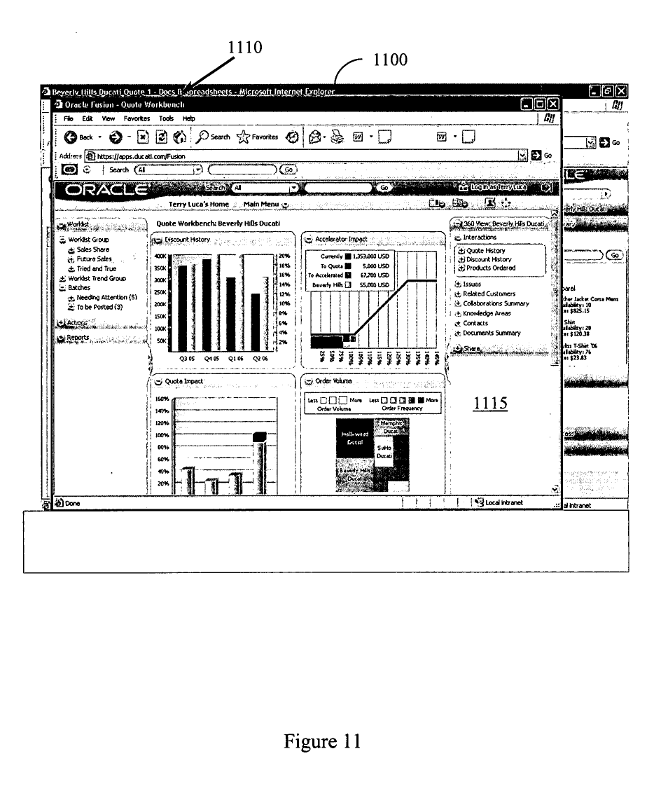

FIG. 10 illustrates a simulated screen shot 1000 showing a personal object processing application (Documents and Spreadsheets) and a region 1020 produced by an example system and/or method. A document 1030 and a spreadsheet 1040 are combined as a quote 1015. Additional context relevant data 1050 and controls associated with additional context relevant actions 1060 appear in region 1020. The additional data 1050 and additional controls 1060 are context relevant to the selection (e.g., quote 1015) made in the personal object processing application. In the screen shot 1000, the selection may have automatically been made as a result of the choice made in association with screen shot 900 (e.g., “opening” a quote). The data and actions available with respect to quote 1015 are relevant to the context, which includes identity (e.g., salesperson), action (e.g., looking at quote), and object (e.g., which quote). One action for which a control 1060 is provided may be to analyze the quote 1015. FIG. 11 illustrates the effect of making this choice.

FIG. 11 illustrates a simulated screen shot 1100 showing an application 1110 (Oracle Fusion, Quote Workbench) on which data and analytics 1115 underlying quote 1015 (FIG. 10) are presented. These data and analytics 1115 are context relevant (e.g., salesperson looking at quote 1015) and are available because example systems and methods created and/or maintained context associated with the selection in the personal object processing application. This context facilitated accessing the data and analytics 1115 available from an enterprise object processing application(s). Clearly quote 1015 (FIG. 10) is not “just data” when region 1020 (FIG. 10) can provide access to data and analytics 1115.

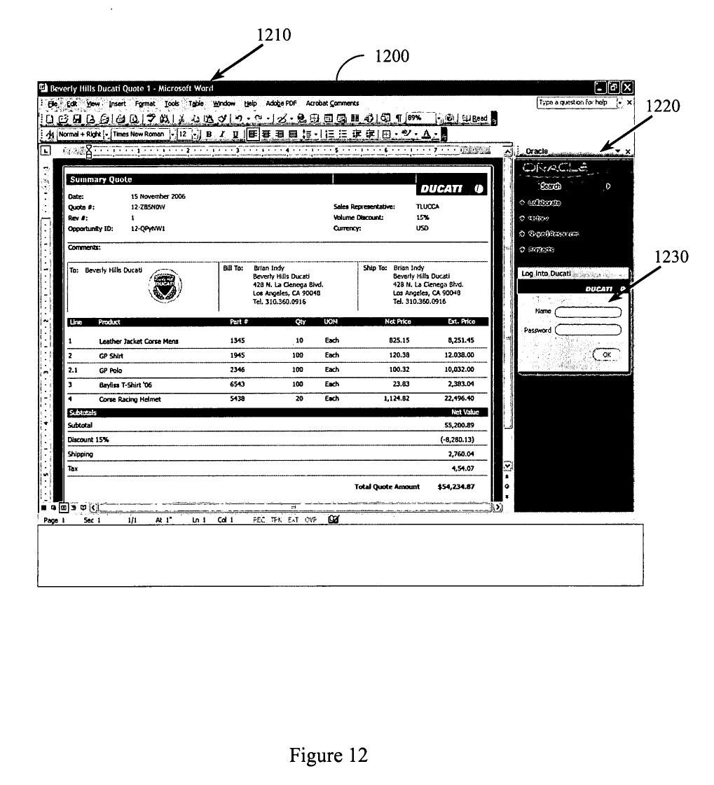

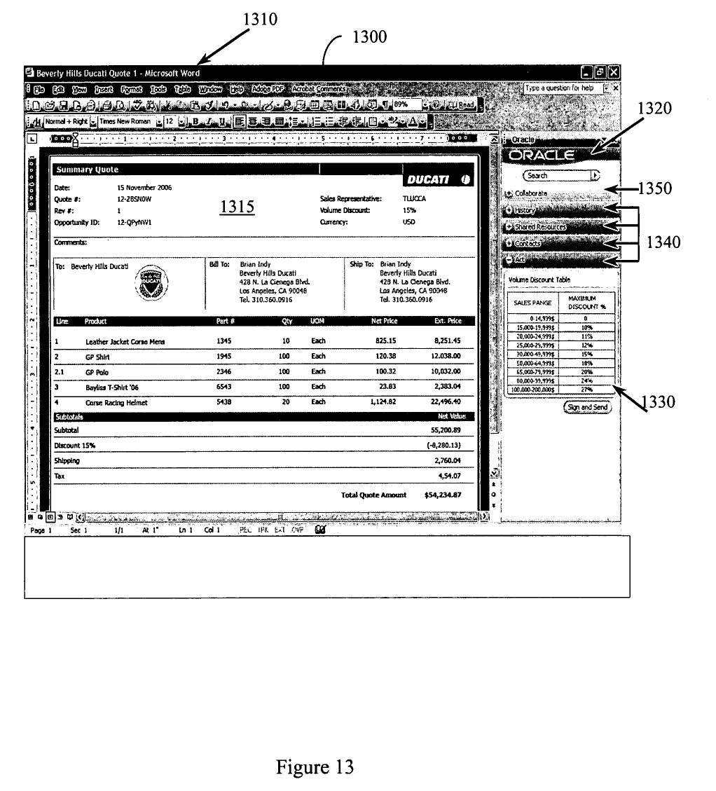

To further understand the role of context, we turn now to FIG. 12, which illustrates a simulated screen shot 1200 showing a personal object processing application 1210 and a region 1220 produced by an example system and/or method. This screen shot 1200 resembles screen shot 1000 in that a document and spreadsheet associated with a quote are presented. Now, however, the point of view is from a customer associated with the quote. The customer is viewing the quote using Word after receiving it via an email from the salesperson associated with screen shot 1000. The customer has a login area 1230 in region 1220. This customer login area 1230 facilitates capturing data from which context can be created. This login data may be coupled with other available data describing which application the customer is using to view the quote, which quote is being viewed, who sent the quote, and so on. After logging in, the customer may be presented with screen shot 1300 (FIG. 13).

Screen shot 1300 shows the personal object processing application 1310 and data associated with the personal object 1315 being viewed. Screen shot 1300 also illustrates region 1320 in which additional data 1330 and controls associated with additional actions 1340, 1350 are presented. These data 1330 and controls 1340, 1350 are relevant to the context, which includes the customer as the viewer and the particular quote received from a particular salesperson as being viewed. The additional data 1330 may describe discounts available to the customer while an action associated with control 1350 may allow the customer to communicate with the salesperson concerning quote 1315. Compare the data 1330 and actions 1340, 1350 available to the customer through screen shot 1300 and the data 1050 and actions 1060 available to the salesperson through screen shot 1000 (FIG. 10). These different sets of data and actions provide an example of “context relevance”.

By selecting the collaborate action 1350, the customer may be presented with screen shot 1400, which includes the customer personal object application 1410 displaying quote 1415 and the region 1420. In region 1420, additional data 1430 and controls associated with additional actions 1440 are presented. Control 1450 and data associated with control 1450 represent a chat session with the salesperson who provided quote 1415 in an email. Access to this collaboration with this salesperson through this collaboration tool is facilitated by the context that was detected, created, and maintained by example systems and methods.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
a capture logic to receive one or more of, an identifier of a selection associated with a personal object processing application, a value associated with the selection, and a metadata describing one or more of, the selection, the value, and the personal object processing application; and
a region logic to provide a viewable region for the personal object processing application, the viewable region to display one or more of, a context relevant action associated with the selection, and a context relevant data associated with the selection, the context relevant action and the context relevant data being associated with an enterprise object processing application related to the selection.

2. The system of claim 1, the capture logic to create a context from one or more of, the identifier, the value, and the metadata.

3. The system of claim 2, the context to include one or more of, an identifier of a selection user, a user name associated with the selection user, a security credential associated with the selection user, a task associated with the selection user, a role associated with the selection user, a location of the selection user, an object associated with the value, an object associated with the selection, and an object associated with the selection user.

4. The system of claim 2, where the metadata includes one or more of, a link to a value, a link to a document, data describing a personal object associated with the selection, data describing a personal object processing application associated with the selection, data describing an enterprise object associated with the selection, data describing an enterprise object processing application associated with the selection, data describing a format associated with the value, data describing a freshness associated with the value, data describing a source associated with the value, data describing an access time associated with the value, data describing a recipient of the value, data describing a provider of the value, and data describing a document associated with the value.

5. The system of claim 3, the region logic to produce the context relevant action associated with the selection and the context relevant data associated with the selection based, at least in part, on the context.

6. The system of claim 5, the context relevant action being one of, a business analytic associated with the enterprise object, and a business task associated with an enterprise object associated with the enterprise object processing application related to the selection.

7. The system of claim 6, the context relevant data being data associated with the enterprise object.

8. The system of claim 1, the capture logic to maintain concurrency between the value in the personal object processing application and a corresponding value in an enterprise object processed by the enterprise object processing application.

9. The system of claim 1, the selection being one of, an object, a field, and a control.

10. The system of claim 1, the selection being one of, an object, a field, and a control,
the capture logic to create a context from one or more of, the identifier, the value, and the metadata, and to maintain concurrency between the value in the personal object processing application and a corresponding value in an enterprise object processed by the enterprise object processing application,
the context to include one or more of, an identifier of a selection user, a user name associated with the selection user, a security credential associated with the selection user, a task associated with the selection user, a role associated with the selection user, a location of the selection user, an object associated with the value, an object associated with the selection, and an object associated with the selection user,
the metadata to include data describing one or more of, a link to a value, a link to a business object, a link to a document, a personal object associated with the selection, a personal object processing application associated with the selection, an enterprise object associated with the selection, an enterprise object processing application associated with the selection, a format associated with the value, a freshness associated with the value, a source associated with the value, an access time associated with the value, a recipient of the value, a provider of the value, and a document associated with the value,
the region logic to produce the context relevant action associated with the selection and the context relevant data associated with the selection based, at least in part, on the context,
the context relevant action being one of, a business analytic associated with the enterprise object, and a business task associated with the enterprise object,
and
the context relevant data being data associated with the enterprise object.

11. A machine-readable medium having stored thereon machine-executable instructions that if executed by a machine cause the machine to perform a method, the method comprising:
receiving a first set of data from a personal object processing logic, the first set of data including a selection identifier associated with the personal object processing logic;
receiving a second set of data from an enterprise object processing logic, the second set of data being determined, at least in part, by the selection identifier;
creating a context associated with the personal object processing logic, the context depending, at least in part, on data associated with a selection identified by the selection identifier; and
providing to the personal object processing logic a set of context relevant display elements, the context relevant display elements depending, at least in part, on the context, the context relevant display elements being related to one or more of, data and processes associated with the enterprise object processing logic.

12. The machine-readable medium of claim 11, the first set of data including one or more of, a personal object, a personal object identifier, a value available in the personal object, a personal metadata, and a personal object processing logic identifier.

13. The machine-readable medium of claim 12, the personal metadata including data describing one or more of, a format of the value, a freshness associated with the value, a freshness associated with the personal object, a source associated with the value, a source associated with the personal object, an access time associated with the value, an access time associated with the personal object, and a document associated with the value.

14. The machine-readable medium of claim 13, the second set of data including one or more of, an enterprise object, an enterprise object identifier, an enterprise metadata, and an enterprise object processing logic identifier.

15. The machine-readable medium of claim 14, the enterprise metadata including data identifying a set of actions available to process the enterprise object.

16. The machine-readable medium of claim 15, the selection identifier being one of, a globally unique identifier (GUID), and a uniform resource locator (URL).

17. The machine-readable medium of claim 16, the context including one or more of, a selection user identifier, a selection user security metadata, a selection user task, and a selection user role.

18. The machine-readable medium of claim 17, the set of context relevant display objects including a context relevant data item related to a data item associated with the enterprise object.

19. The machine-readable medium of claim 17, the set of context relevant display objects including a context relevant control item related to an action associated with the enterprise object.

20. A system, comprising:
means for receiving a first data concerning a selection in a personal object processing application;
means for receiving from an enterprise object processing application a second data related to the selection;
means for creating a context for the selection, the context being created from one or more of, elements of the first data, and elements of the second data; and
means for providing to the personal object processing application data and functionality associated with the enterprise object processing application, the data and functionality being determined by the context.
